(19) United States
(12) Patent Application Publication
(10) Pub. No.: US 2010/0213140 A1
(43) Pub. Date: Aug. 26, 2010

(54) Disposable strainers for pop-up and basin drains

(76) Inventor: Haion Won, Basking Ridge, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 12/799,331

(22) Filed: Apr. 22, 2010

Related U.S. Application Data
(63) Continuation-in-part of application No. 12/284,568, filed on Sep. 23, 2008, now Pat. No. 7,736,499.
Application No. 12/284,568 is a continuation-in-part of application No. 11/440,760, filed on May 25, 2006, now Pat. No. 7,442,296.

(51) Int. Cl. E03F 5/14; C02F 1/00

(52) U.S. Cl. 210/767; 210/163

(57) ABSTRACT

A disposable drain strainer for a pop-up and basin drain includes a top opening to accommodate the upward position of the pop-up drain stopper during drainage of the basin/sink or bathtub. The disposable drain strainer has a strainer portion, a ring portion, and at least one adjustable leg. The strainer portion comprises strainer walls abutting a strainer top shelf having a top opening. At least the strainer walls include a plurality of apertures for drainage. The top opening is appointed to engage and receive a pop-up drain stopper when the stopper is in an opened position as during draining. The ring portion fixedly attached to the strainer walls of the strainer portion. At least one adjustable leg is provided arranged adjacent to the top opening and being appointed to engage with the stopper when the stopper is in the opened position. Advantageously, the top opening and adjustable legs engage the pop-up drain stopper when it is opened during drainage so that the strainer optimally provides filtering of debris.

### CROSS-REFERENCE TO RELATED APPLICATIONS

This application is a continuation-in-part of Attorney Docket No.: 0285-1 CIP2, filed of even date herewith, entitled “Ultra Thin Disposable Sink Drain Strainer” which, in turn, is a continuation-in-part of U.S. patent application Ser. No. 12/284,568, filed Sep. 23, 2008, entitled “Disposable Sink Drain Strainer” which, in turn, is a continuation-in-part of U.S. application Ser. No. 11/440,760, now U.S. Pat. No. 7,442,296, filed on May 25, 2006, the disclosure of which is hereby incorporated by reference.

### BACKGROUND OF THE INVENTION

1. Field of the Invention

The present invention relates to sink drain strainers appointed to be used in conjunction with a drain opening of a plumbing fixture including a sink, shower and/or bathtub; and more particularly, to a disposable drain strainer for pop-up and basin drains accommodates the upward position of the pop-up drain stopper during drainage of the basin/sink or bathtub.

2. Description of the Prior Art

Strainer devices for drains are commonly utilized for preventing debris from entering drains of kitchen, bathroom, and shower or bath plumbing fixtures. These devices require frequent cleaning as debris accumulates causing fluid passage through the strainer to be slowed and, consequently, water back up and slowed drainage from the sink. Moist environments inherent to plumbing fixtures aggregated with accumulation of food particles and other debris creates an ideal breading ground for bacterial growth within the debris itself, the drain strainer/filter, sink, and overall plumbing.

Cleaning of these devices is often an undesirable task, and can be difficult in removing entangled debris therefrom without intimate contact with the debris. In addition, removal of a strainer from the sink can be cumbersome particularly when the strainer is moistened from water and heavy with debris. Handling of the debris filled strainer in removal of the debris exposes the handler to harmful bacteria. Despite cleaning or removal of the debris placement of the contaminated strainer back in the drain can be unsanitary, and in addition, many times small amounts of stubborn debris remain entangled in the apertures of the strainer. Remaining debris entrapped in the strainer can result in sink drainage problems, compound bacterial growth, and eventually wash through the strainer and clog the joints of domestic water and sewer lines.

Moreover, sink strainers either generally must sit within the sink basin, and many times include a stopper device integrated therein, or sit overtop of a sink stopper device. Many pop-up sink stopper devices integrated within the plumbing fixture include a shaft attached to a stopper top that moves upward in the tub/sink to allow water to escape, and moved downward to close off the drain when the tub/sink retains water. Strainer devices have difficulty properly covering the sink stopper device as well as the drain when the stopper is upward during drainage. As a result, improper fit of the strainer generally either requires the strainer to be removed during draining, or retained thereon but in a deformed manner that allows for debris to pass under the strainer device.

Another disadvantage currently involving strainer devices involves slow drainage issues due in part to the lack of drainage on the side perimeters of the device. Drainers heretofore currently in general only provide drain holes on the top surface of the strainer and do not provide side drainage. Lack of side drainage holes contributes to drainage inefficiency and slow drain time.

Various types of strainer devices for plumbing fixtures attempt to attend to the aforementioned problems associated with debris accumulation, removal, and bacterial growth. However, none of these drain strainers or filters provide a simple, economically conducive, sanitary strainer composed of a flexible material, which can be readily removed from the sink and disposed of, thereby providing a more sanitary sink environment. Moreover, none of the drain strainers heretofore disclosed and utilized provides a ready release means so that the strainer or filter is removed from the drain with minimal effort. Additionally, none of the heretofore disclosed and utilized drain strainers provides a pop-up feature that allows the drain to fit over and adjust to drain stoppers integrated within the sink/drain.

U.S. Pat. Nos. 5,535,455, 5,397,464, 6,387,261, 4,045,351 and 4,024,062 disclose drain strainer devices generally integrated within plumbing fixtures. The integrated sink drain strainer devices have limitations because they cannot be simply placed over the exterior of the drain and readily cleaned or discarded when soiled. Integration of strains within plumbing fixtures results in issues involving sink drain compatibility, installation and increased overall manufacturing costs. Moreover, accessing the strainer or filter element for cleaning or replacement can become cumbersome and time consuming.

U.S. Pat. Nos. 6,303,032 and 5,486,287 disclose drain strainers or filters that covers a substantial portion of a sink's bottom, and does not merely provide filtering or straining over the drain area. These types of strainers are not disposable in nature and are appointed for continuous reuse. Debris must be cleaned from the device, and bacteria growth is likely promoted. Moreover, the devices do not provide a pop-up feature so that they cannot be efficiently utilized with a pop-up strain stopper device.

U.S. Pat. Nos. 6,601,242, 4,984,309, 4,910,811, 4,706,306 and 4,205,710, as well as www.ImprovementsCatalog.com disclose drain strainer combination devices, such as combined drain-strainer, strainer—plug and funnel—strainer combinations. These devices have several limitations because they are not disposable, and are instead continuously re-used. Therefore debris must be cleaned from these devices regularly. These devices do not provide a removal means, such as a tab or other release means, and as a result are inherently difficult to retrieve from the sink's drain. What is more, the devices do not provide a pop-up feature so that they cannot be efficiently utilized with a pop-up strain stopper device.

U.S. Pat. Nos. 5,376,264, 4,134,162 and 3,982,289 disclose disposable strainers assemblies. The assemblies concern disposable filters and strainers but have limitations because of the lack of ability to provide for an ultra thin strainer appointed to be discarded upon single use. Moreover, none of the disposable strainers provide for a biodegradable or edible composition. As a result, frequent disposal of the conventional disposable strainers is both economically steep as well as environmentally harmful. Moreover, the devices do not provide a pop-up feature so that they cannot be efficiently utilized with a pop-up strain stopper device.

Notwithstanding the efforts of prior art workers to construct a drain strainer for plumbing fixtures there remains a need in the art for a disposable drain strainer having a thin pop-up construction. In particular, there is a need in the art for a lightweight, economical, sanitary strainer having top and side drainage holes. Moreover, there is a need in the art for a drain strainer that is constructed having a top opening appointed to receive and accommodate a pop-up sink stopper mechanism during drainage.

### SUMMARY OF THE INVENTION

The present invention provides a lightweight, thin disposable drain strainer removabley received within a drain opening having an adjacent drain rim substrate, and method of use. The disposable drain strainer is particularly provided for use with top opening to accommodate pop-up and basin a drain stoppers moved to the upward position during drainage of the basin/sink or bathtub.

The disposable drain strainer has a strainer portion, a ring portion, and at least one adjustable leg. The strainer portion comprises strainer walls abutting a strainer top shelf having a top opening. At least the strainer walls include a plurality of apertures for drainage. Side wall apertures provide increase drainage efficiency as the water seeps through the apertures and under the sides of the opened pop-up stopper. The top opening is appointed to engage and receive a pop-up drain stopper when the stopper is in an opened position as during draining. The ring portion fixedly attached to the strainer walls of the strainer portion. At least one adjustable leg is provided arranged adjacent to the top opening and being appointed to engage with the stopper when the stopper is in the opened position. Advantageously, the top opening and adjustable legs engage the pop-up drain stopper when it is opened during drainage so that the strainer optimally provides filtering of debris. With use of the disposable drain strainer, pop-up types of drains can be protected by the strainer despite variations in the diameters of the drains.

Additionally, a seal release means may be provided that is integral within the ring portion for facilitating release of the ring portion and removal of the strainer from the drain. The seal release means comprises a press-release integrated within the ring portion so that the ring portion further comprises arced ring walls having convex and concave configurations with a ring edge. The convex configuration is engaged when the ring portion forms the seal with the adjacent drain rim area. Conversely, the concave configuration is engaged when the top portion of the ring portion is pressed, the seal being released and the disposable drain strainer being removed from the drain opening and discarded.

A method of using a disposable drain strainer with a drain opening having an adjacent drain rim substrate is provided. The method comprises the first step of placing the disposable drain strainer on top of a drain having a pop-up drain stopper integrated therein. The disposable drain strainer includes strainer walls abutting a strainer top shelf having a top opening. At least the strainer walls include a plurality of apertures. The top opening is appointed to engage and receive the pop-up drain stopper when the stopper is in an opened position as during draining. A ring portion is fixedly attached to the strainer walls of the strainer portion. Additionally, at least one adjustable leg is provided (preferably at least three are provided) adjacent to the top opening and being appointed to engage with the stopper when the stopper is in the opened position. The method comprises the second step of aligning the strainer portion and the top opening and adjustable legs with the pop-up drain stopper. When the pop-up drain stopper is in a closed position the strainer portion and visa vie the adjustable legs remain in the downward position. Conversely, when the pop-up drain stopper is in an open position the stopper traverses through the top opening and presses against the adjustable legs causing the legs to securely hold the strainer on the stopper and visa vie the drain.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1 illustrates a top planer view of an embodiment of the disposable sink drain strainer for pop-up and basin drains;

FIG. 2a illustrates a cross-sectional view of the drain strainer of FIG. 1a taken along line X-X′ alone, and then placed on and engaging with a pop-up drain stopper wherein the strainer has a larger diameter;

FIG. 2b illustrates a cross-sectional view of the drain strainer of FIG. 1a taken along line X-X′ alone, and then placed on and engaging with a pop-up drain stopper wherein the strainer has a smaller diameter;

FIG. 3a illustrates a top planer view of an embodiment of the disposable sink drain strainer for pop-up and basin drains alone, and then placed on and engaging with a pop-up drain stopper;

FIG. 3b illustrates a cut-away view of the embodiment of FIG. 3a wherein the strainer is placed over a bathtub pop-up drain stopper, wherein the drain stopper is in the closed condition; and

FIG. 3c illustrates a cut-away view of the embodiment of FIG. 3a wherein the strainer is placed over a bathtub pop-up drain stopper, wherein the drain stopper is in the open condition.

### DETAILED DESCRIPTION OF THE INVENTION

The invention provides a lightweight, ultra-thin disposable drain strainer removabley received within a drain opening having an adjacent drain rim substrate and a pop-up drain stopper. The disposable drain strainer is particularly provided for use with pop-up and basin a drain stoppers to accommodate the upward position of the pop-up drain stopper during drainage of the basin/sink or bathtub. The disposable drain strainer is constructed having a strainer portion having walls with apertures and a top shelf abutting to a top opening, a ring portion, and at least one adjustable leg located within the top opening. The strainer portion comprises strainer walls and a top shelf having an opening. A plurality of small apertures is integrated within the strainer portion, preferably at least in the strainer walls, but apertures may also be included in the top shelf of the strainer portion. The adjustable leg is appointed to adjust to engage with the stopper when the stopper is pressed upward during drainage. As the stopper moves upward it comes into contact with the adjustable legs (preferably at least three adjustable legs are provided) which deform to engage the stopper's plunger as the stopper passes through the top opening. Advantageously, the adjustable legs mechanically bend as the pop-up drain stopper is opened during drainage and presses against the stopper's plunger. Conversely, the adjustable legs unbend downward when the pop-up drain stopper is closed during water containment and depresses from the strainer. Owing to its ability to accommodate drains having drain stoppers integrated therein the strainer has a plethora of applications and will not interfere with drain stoppers. Preferably the strainer is composed of a thin material including flexible polymeric materials, silicone, or rubber. Alternatively, the strainer may be composed of more rigid materials. In yet another alternative embodiment, the strainer is composed of a biodegradable material and is preferably intended for single use. The disposable drain strainer may be composed of cornstarch, or sugarcane, and may further comprise a water-insoluble edible film. Further, the disposable drain strainer may include environmentally friendly binding agents, such as that set forth under SGS. Alternatively, the disposable drain strainer is composed of a biodegradable thermoplastic derived from lactic acid, polylactide (PLA).

The strainer may be provided as an ultra-thin strainer having a thickness no greater than 0.091 cm (0.036 inch) for increased disposability. Alternatively, the strainer has a thickness of 0.45 cm. In another embodiment the strainer includes a seal release mechanism. Top and bottom surfaces of the ring portion are adapted to sealingly engage the drain rim substrate. The disposable drain strainer is preferably composed of a biodegradable or environmentally friendly material. The disposable strainer may be composed of a variety of materials, including fiber materials, polymeric materials, starch, sugarcane, or water-insoluble edible film. Wherein the strainer is composed of a material soluble in water, the strainer preferably includes a water-insoluble edible film coating. Owing to its thin nature, the disposable drain strainer is appointed to be disposed after use so that the user does not have to clean the strainer and is cost efficient to produce and transport. Due to the strainer's environmentally friendly composition the strainer can be readily discarded without harming the environment.

The disposable drain strainer can be readily placed in a drain to effect substantial sealing engagement with the drain perimeter so that debris is retained by the strainer while water and other fluids pass therethrough. When the disposable drain strainer is filled with debris, the strainer is simply discarded along with the debris. Preferably the strainer is appointed for a single use—or one time use—so that it is discarded after use and a new strainer provided in its place. Upon removal from the drain, the strainer device and the debris therein can be readily discarded.

Due to the thinness of the strainer, the strainer can be manufactured, packaged and transported with minimum cost. At the same time, the thinness of the strainer provides cost benefit as to the disposable nature of the strainer; as the ultra-thin strainer is cheaper to manufacture, package and transport, the disposability of the strainer is feasible with minimum cost to the consumer for replacement. Preferably the strainer is sold in a package including a plurality of strainers therein—which may be sold as a stack of disposable ultra-thin strainers.

Advantageous resultant from the ultra-thin nature of the strainer include providing a lighter weight strainer that is less expensive to manufacture, easier to handle, lower transportation and packaging costs, lower insurance costs and import taxes, and a strainer that is green for the environment. The ultra-thin disposable drain strainer can be readily placed in a drain to effect substantial sealing engagement with the drain perimeter so that debris is retained by the strainer while water and other fluids pass therethrough. When the disposable drain strainer is filled with debris, the strainer is simply discarded along with the debris. Preferably the strainer is appointed for a single use—or one time use—so that it is discarded after use and a new strainer provided in its place. Upon removal from the drain, the strainer device and the debris therein can be readily discarded.

Advantageously, the open top nature of the strainer allows the strainer to automatically accommodate the pop-up drain stopper as it is opened for drainage. As a result, the strainer maintains optimal draining ability without compromising the positioning of the strainer. Users will not have to remove or manually adjust the strain during drainage. What is more, the strainer walls include a plurality of wall apertures, which may be elongated, integrated therein which aid in the effective drainage of water and collection of debris. These side apertures increase water drain speed resulting in a more effective strainer. The wall apertures may be constructed in a plethora of sizes and shapes, and are preferably constructed as substantially elongated holes. The elongated hole construction provides optimal water flow through the drain while at the same time is thin in nature so as to prevent debris from passing through the elongated holes. Preferably, side wall apertures have a width of 4.00 cm and a height of 12 cm. The top of the strainer portion further includes the plurality of small apertures. These top apertures preferably have a diameter of 4.00 mm. The top strainer apertures may include at least two different aperture sizes and/or shapes to provide optimal water drainage while at the same time filtering out debris. The strainer is preferably 41.00 cm in diameter. The strainer portion is preferably 35.00 cm in diameter; the expandable inner ring is preferably 37.00 cm in diameter.

The adjustable legs are constructed having a first portion and a second portion separated by a flexure joint so that the second portion readily bends and flexes when a force is applied. The adjustable legs are resilient and flex upward and downward as force is applied/un-applied against the strainer. Optionally, the adjustable legs are composed of a flexible resilient material such as a silicone, rubber, flexible polymeric, fiber, or other flexible material.

The ultra-thin strainer may be composed of a polymeric material selected from the group consisting of polypropene (PP), Polyethylene Terephthalate (PET or PETE), Acrylonitrile and butadiene styrene (ABS). Alternatively, the disposable drain strainer may be composed partly of polystyrene in the form of extruded polystyrene foam such as that commonly sold under the trade name STYROFOAM of Dow Chemical Company. For environmental benefits, the disposable drain strainer may be composed of a fiber material, paper, cardboard, etc., or may be composed of starch or sugarcane. Most preferably, the ultra-thin strainer is composed of a degradable environmentally friendly material such as a fiber material or paper material. Further, the ultra-thin strainer may be composed of an edible material so that animals can feed off the disposed strainer, such as starch, sugarcane, rice bran, polylactide (PLA), or a water-insoluble edible film such as that disclosed in U.S. Pat. No. 5,543,164. Such starches may include rice, wheat, maize (corn), potatoes and cassava, or modified food starch products. As the strainer is appointed to be utilized in the presence of water, preferably the strainer includes a water-insoluble edible film coating such as that disclosed in U.S. Pat. No. 5,543,164. When the ultra-thin strainer is composed of a water soluble compound, such as some starches, it preferably includes a water insoluble coating or film as discussed to mitigate solubility during use in the sink or tub. For example, the ultra-thin strainer may be composed of or coated with a water-insoluble edible film including mixtures of protein [whey protein, preferably]/beeswax/sorbitol edible emulsion films such as that disclosed in U.S. Pat. No. 5,543,164. Alternatively, the coating may simply consist of a thin wax coating, and or gelatin coating to provide a barrier against water solubility of the strainer.

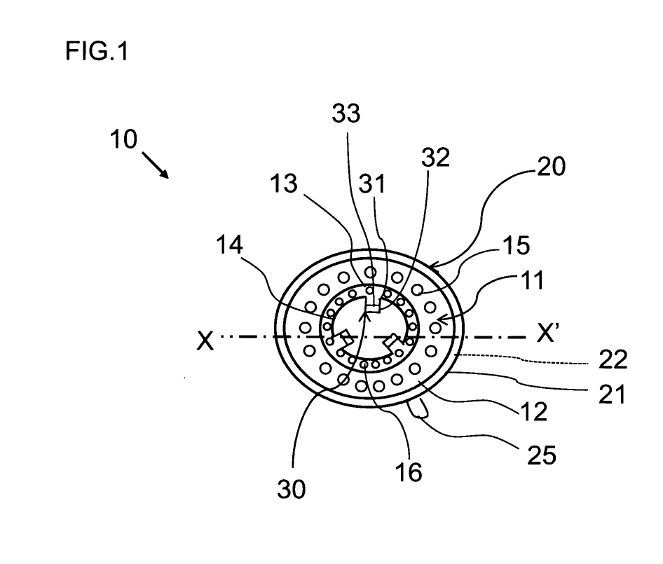

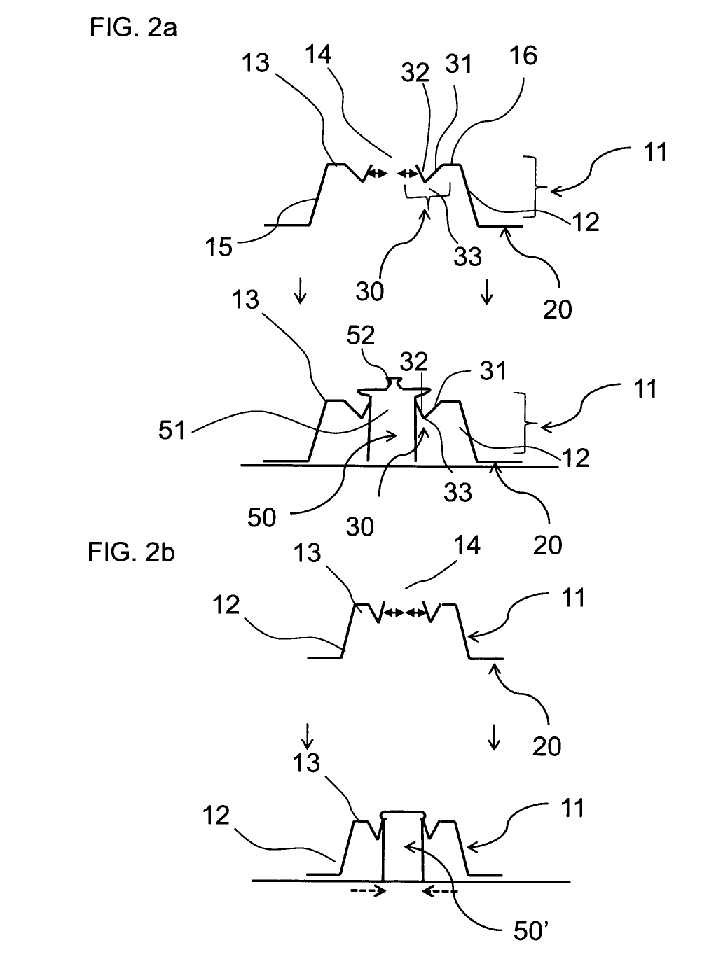

FIG. 1 illustrates a top planer view of an embodiment of the disposable sink drain strainer for pop-up and basin drains, shown generally at 10. FIGS. 2a-2b illustrates cross-sectional views of the drain strainer of FIG. 1a taken along line X-X′ alone, and then placed on and engaging with a pop-up drain stopper wherein the strainer has a larger diameter/smaller diameter. The disposable drain strainer 10 comprises a strainer portion 11 comprising strainer walls 12 and a top shelf 13 having a top opening 14. A plurality of small apertures 15 is integrated within the strainer portion 11, preferably at least in the strainer walls 12, but apertures 16 may also be included in the top shelf 13. A ring portion 20 is provided and circumferentially surrounds walls 12. At least one adjustable leg 30 is located and appends from top opening 14. Preferably at least three adjustable legs 30 are provided in a staggered confirmation running circumferentially along top opening 14 as shown. Adjustable legs 30 are appointed to adjust to engage with a pop-up drain stopper 50, 50′ (smaller diameter stopper) when the stopper 50 is pressed upward during drainage. As the stopper 50 moves upward it comes into contact with the adjustable legs 30 which deform to engage the stopper's plunger 51 as the stopper top 52 passes through the top opening 14. Advantageously, the strainer 10 is appointed to be one-size-fits all strainer as the top opening can accommodate stoppers 50 of different diameters as shown via FIGS. 2a, 2b.

The strainer portion 11 is provided with a plurality of small apertures 15 in the strainer walls 12 and alternatively the top shelf 13. The plurality of small apertures 15, 16 are of a size and shape sufficiently small that debris are prevented from passing beyond a drain opening having a pop-up drain stopper and into the drain pipe, while drainage water is allowed to pass through the accumulated debris and apertures 15, 16. Preferably, these pluralities of small apertures 15, 16 range in diameter between 0.1 cm to 0.4 cm, and most preferably at 0.4 cm in diameter. Optionally, the plurality of small apertures each have a slightly tapered configuration with sloped walls, wherein the top of the apertures is wider than the bottom of the aperture so that smaller food particles pass the top of the aperture but are trapped nearer the bottom of the aperture where the aperture is tapered. The disposable drain strainer is ultra-thin, having a thickness ranging from 0.091 cm (0.036 inch) to 0.45 cm (0.177 inches).

The disposable drain strainer 10 further comprises ring portion 20 fixedly attached to strainer walls 12 of strainer portion 11. Ring portion 20 may have a shallow depth so that it forms only a small or thin ring around strainer portion 11. Ring portion 20 further comprises a top surface 21 and bottom surface 22. Ring portion 20 is constructed and arranged to engage with and optionally form a seal with adjacent drain rim area of drain opening. This seal between ring portion 20 and the adjacent drain rim area substantially prevents the seepage and passage of wayward debris from bypassing strainer portion 11 and undesirably entering the drain opening and potentially clogging the plumbing piping. Optionally, ring portion 20 further comprises a seal gasket or a suction-cup gasket.

The apertures 15, 16 effectively drain water while collecting debris. Side/wall apertures 15 increase water drain speed resulting in a more effective strainer. The wall apertures may be constructed in a plethora of sizes and shapes, and are preferably constructed as substantially elongated holes. The elongated hole construction provides optimal water flow through the drain while at the same time is thin in nature so as to prevent debris from passing through, the elongated holes. Preferably, side wall apertures have a width of 4.00 cm and a height of 12 cm. The top of the strainer portion, via top shelf 13, preferably further includes the plurality of small apertures 16. These top apertures preferably have a diameter of 4.00 mm.

The disposable drain strainer's 10 preferably includes at least three adjustable legs 30. Adjustable legs 30 are constructed having a first portion 31 and a second portion 32 separated by a flexure joint 33. Flexure joint 33 allows first and second portions 31, 32 to bend and flex in relation to one another and such joint may simply include a perforation or bendable region. The second portion 32 readily bends and flexes when a force is applied, as when stopper 50 passes upward between the adjustable legs 30 and traverses upward into top opening 13. As the stopper 50 passes second portion 32 it causes it to bend upwardly so that portion 32 presses against the stopper plunger 51. Conversely, when the stopper 50 is lowered, the force against second portion 32 ceases and portion 32 flexes back to its original position in relation to first portion 31. Strainer portion 11 is removably received within a drain opening having an adjacent drain rim area and a pop-up drain stopper. The drain is preferably a kitchen sink drain or rinse basin, bath tub, shower, or the like, affixed to a plumbing fixture. The drain may be a bathroom sink drain or shower or tub drain. The size of the disposable drain strainer can vary to accommodate a vast array of sink drain sizes, shapes, and depths. The disposable drain strainer 10 may further comprise a seal release means, herein shown as tab 25, integrated within ring portion 20. Optionally, the strainer 10 further comprises an external water-insoluble coating to mitigate dissolving of the strainer 10 when in use wherein the strainer 10 is composed of a starch or sugar soluble in water. What is more, optionally an interior surface and exterior surface of tab 25 may include a friction coating fixed thereon to facilitate easy grasping of tab 25 by an individual. This friction coating provides enhanced grasping that enables the user to apply enough force to break the seal and remove the disposable strainer 10 from the drain, while mitigating slippage of the fingers. This friction coating feature is especially advantageous, as debris and moisture or water droplets on tab 25 tend to cause a slippery grasp, which can heighten the difficulty of breaking the seal and removing a debris laden strainer. Alternatively, the interior surface of tab 25 has a friction coating fixed thereon to facilitate easy grasping of tab 25; and exterior surface does not include the friction coating. Optionally, tab 25 has an inner aperture fixed therein to facilitate easy grasping of tab 25 by the user.

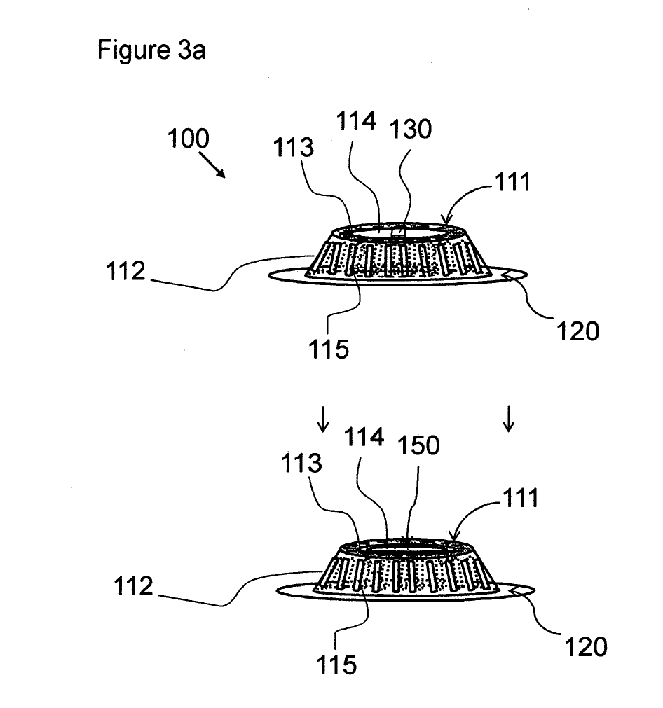

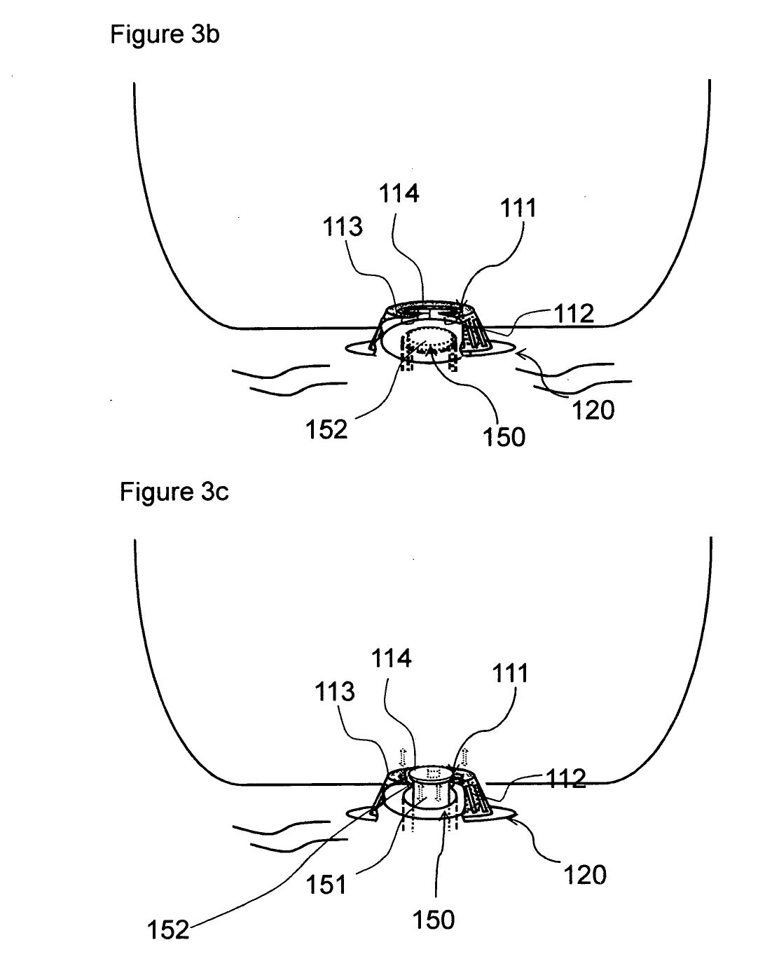

FIGS. 3a-3c illustrate a top planer view of an embodiment of the disposable sink drain strainer for pop-up and basin drains alone, and then placed on and engaging with a pop-up drain stopper. FIG. 3b illustrates a cut-away view of the embodiment of FIG. 3a wherein the strainer is placed over a bathtub pop-up drain stopper, wherein the drain stopper is in the closed condition. FIG. 3c illustrates a cut-away view of the embodiment of FIG. 3a wherein the strainer is placed over a bathtub pop-up drain stopper, wherein the drain stopper is in the open condition. The disposable drain strainer 100 comprises a strainer portion 111 comprising strainer walls 112 and a top shelf 113 having a top opening 114. A plurality of small apertures 115 is integrated within the strainer portion 111, preferably at least in the strainer walls 112, but apertures 116 may also be included in the top shelf 113. A ring portion 120 is provided and circumferentially surrounds walls 112. At least one adjustable leg 130 is located and appends from top opening 114. Preferably at least three adjustable legs 130 are provided in a staggered confirmation running circumferentially along top opening 114. Adjustable legs 130 are appointed to adjust to engage with a pop-up drain stopper 150 when the stopper 150 is pressed upward during drainage. As the stopper 150 moves upward it comes into contact with the adjustable legs 130 which deform to engage the stopper's plunger 151 as the stopper top 152 passes through the top opening 114. Ring portion 120 may have a shallow depth so that it forms only a small or thin ring around strainer portion 111. Ring portion 120 further comprises a top surface 21 and bottom surface 22. Ring portion 120 is constructed and arranged to engage with and optionally form a seal with adjacent drain rim area of drain opening.

Preferably, the disposable drain strainer device is composed of a polymeric material. The polymeric material may be selected from the group consisting of Polyethylene (PE), Polypropylene (PP), or Polyethylene Terephthalate (PET or PETE). Most preferably, the ultra-thin strainer is composed of a degradable environmentally friendly material such as a fiber material or paper material. Further, the ultra-thin strainer may be composed of an edible material so that animals can feed off the disposes strainer, such as starch, sugarcane, or a water-insoluble edible film such as that disclosed in U.S. Pat. No. 5,543,164. Such starches may include rice, wheat, maize (corn), potatoes and cassava, or modified food starch products. As the strainer is appointed to be utilized in the presence of water, preferably the strainer includes a water-insoluble edible film coating such as that disclosed in U.S. Pat. No. 5,543,164. When the ultra-thin strainer is composed of a water soluble compound, such as some starches, it preferably includes a water insoluble coating or film as discussed to mitigate solubility during use in the sink or tub. For example, the ultra-thin strainer may be composed of or coated with a water-insoluble edible film including mixtures of protein [whey protein, preferably]/beeswax/sorbitol edible emulsion films such as that disclosed in U.S. Pat. No. 5,543,164. Alternatively, the coating may simply consist of a thin wax coating.

The disposable drain strainer device may have a thickness no greater than 0.091 cm (0.036 inch). This thickness limitation and polymeric material composition yields a lightweight, economically viable, yet sturdy disposable strainer product. A thickness of no greater than 0.091 cm enables a disposable strainer to carry a load of debris without strainer breakage. Moreover, a thickness of no greater than 0.091 cm provides the ability to closely pack, ship, and distribute the disposable strainers in a cost effective manner, since many of the disposable strainers can be readily stacked upon one another during shipment and storage, and points of sale. In addition, cost saving benefits can be reaped through savings in raw materials (i.e. less materials being utilized for the thin strainers), production costs, reduced need for solvents and decreased generation of hazardous waste during manufacture.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A disposable drain strainer for use with a drain opening having an adjacent drain rim substrate, comprising:
a. a strainer portion comprising strainer walls abutting a strainer top shelf having a top opening, wherein at least said strainer walls include a plurality of apertures and wherein said top opening is appointed to engage and receive a pop-up drain stopper when said stopper is in an opened position as during draining;
b. a ring portion fixedly attached to said strainer walls of said strainer portion;
c. at least one adjustable leg adjacent to said top opening and being appointed to engage with said stopper when said stopper is in said opened position.

2. A disposable drain strainer as recited by claim 1, wherein there are at least three adjustable legs.

3. A disposable drain strainer as recited by claim 1, wherein said strainer shelf further includes a plurality of top apertures integrated therein.

4. A disposable drain strainer as recited by claim 1, wherein said apertures are constructed as substantially elongated holes.

5. A disposable drain strainer as recited by claim 1, wherein said plurality of apertures of said strainer portion has at least two different aperture sizes.

6. A disposable drain strainer as recited by claim 1, wherein said adjustable leg comprises a first portion and a second portion separated by a flexure joint so that said second portion readily bends and flexes when a force is applied.

7. A disposable drain strainer as recited by claim 1, wherein said adjustable leg is composed of a flexible resilient material.

8. A disposable drain strainer as recited by claim 1, wherein said ring portion includes a top and bottom surface and is adapted to substantially sealingly engage said drain rim substrate.

9. A disposable drain strainer as recited by claim 8 comprising a seal release means.

10. A disposable drain strainer as recited by claim 9, wherein said seal release means is integral within said ring portion for facilitating release of said ring portion and removal of said strainer from said drain, wherein said seal release means comprises a tab pivotally and fixedly attached to said top surface of said ring portion by a connection means, said tab further comprising an interior and an exterior surface.

11. A disposable drain strainer as recited by claim 1, wherein said disposable drain strainer is an ultra thin strainer having a thickness no greater than 0.091 cm (0.036 inch).

12. A disposable drain strainer as recited by claim 1, wherein said disposable drain strainer is composed of a polymeric material selected from a group consisting of polypropene (PP), Polyethylene Terephthalate (PET or PETE), Acrylonitrile and butadiene styrene (ABS).

13. A disposable drain strainer as recited by claim 1, wherein said disposable drain strainer is composed of a fiber material.

14. A disposable drain strainer as recited by claim 1, wherein said disposable drain strainer is composed of starch.

15. A disposable drain strainer as recited by claim 1, wherein said disposable drain strainer is composed of cornstarch.

16. A disposable drain strainer as recited by claim 1, wherein said disposable drain strainer is composed sugarcane.

17. A disposable drain strainer as recited by claim 1, wherein said disposable drain strainer comprises a water-insoluble edible film.

18. A disposable drain strainer as recited by claim 1, wherein said plurality of apertures each have slightly tapered, sloped walls.

19. A disposable drain strainer as recited by claim 1 comprising a tab member for ease in removal of said drain strainer.

20. A disposable drain strainer as recited by claim 1, wherein said ring portion further comprises a seal gasket located on said bottom surface of said ring portion.

21. A disposable drain strainer as recited by claim 1, wherein said ring portion further comprises a suction-cup gasket located on said bottom surface of said ring portion.

22. A disposable drain strainer as recited by claim 1, wherein said disposable drain strainer comprises environmentally friendly binding agent.

23. A disposable drain strainer as recited by claim 1, wherein said disposable drain strainer is composed of a biodegradable thermoplastic derived from lactic acid, polylactide (PLA).

24. A method of using a disposable drain strainer with a drain opening having an adjacent drain rim substrate, comprising steps of:
a. placing said disposable drain strainer on top of a drain having a pop-up drain stopper integrated therein, said disposable drain strainer comprising strainer walls abutting a strainer top shelf having a top opening, wherein at least said strainer walls include a plurality of apertures and wherein said top opening is appointed to engage and receive said pop-up drain stopper when said stopper is in an opened position as during draining, a ring portion fixedly attached to said strainer walls of said strainer portion, and at least one adjustable leg adjacent to said top opening and being appointed to engage with said stopper when said stopper is in said opened position;
b. aligning said strainer portion and said top opening with said pop-up drain stopper.

25. A disposable drain strainer as recited by claim 1, wherein said disposable drain strainer is composed of rice bran.
